(19) United States
(12) Patent Application Publication
(10) Pub. No.: US 2025/0251698 A1
(43) Pub. Date: Aug. 7, 2025

(54) APPARATUS AND METHOD FOR OPTIMIZING IMAGE QUALITY OF ACQUIRED HOLOGRAM

(71) Applicant: ELECTRONICS AND TELECOMMUNICATIONS RESEARCH INSTITUTE, Daejeon (KR)

(72) Inventors: Ki-Hong CHOI, Daejeon (KR); Kee-Hoon HONG, Daejeon (KR); Jae-Hyeung PARK, Seoul (KR)

(73) Assignee: ELECTRONICS AND TELECOMMUNICATIONS RESEARCH INSTITUTE, Daejeon (KR)

(21) Appl. No.: 19/044,831

(22) Filed: Feb. 4, 2025

(30) Foreign Application Priority Data
Feb. 5, 2024 (KR) 10-2024-0017404
Jan. 21, 2025 (KR) 10-2025-0008554

(51) Int. Cl. G03H 1/08; G03H 1/16

(52) U.S. Cl. CPC G03H 1/0891; G03H 1/16

(57) ABSTRACT

Disclosed herein is an apparatus and method for optimizing image quality of an acquired hologram. The method may include constructing a dataset in which a ground truth image is paired with hologram information acquired from the ground truth image, optimizing a transfer function based on a gradient descent method using the constructed dataset, and restoring noisy hologram information based on the optimized transfer function.

### CROSS REFERENCE TO RELATED APPLICATIONS

This application claims the benefit of Korean Patent Applications No. 10-2024-0017404, filed Feb. 5, 2024, and No. 10-2025-0008554, filed Jan. 21, 2025, which are hereby incorporated by reference in their entireties into this application.

### BACKGROUND OF THE INVENTION

### 1. Technical Field

The disclosed embodiment relates to technology for improving image quality of holograms.

### 2. Description of the Related Art

Incoherent holography or self-interference holography acquires an interference pattern through a self-reference method in which incoherent incident light waves emitted or reflected from an object are split spatially or depending on a polarized state. The split light waves are modulated by an interferometer or a polarization modulator, resulting in wavefronts with different curvatures, and then propagated, whereby interference patterns are formed on an image sensor. Here, because the interference occurs between twin light waves originating from light emitted at the same spacetime, it is independent of light source conditions. Therefore, image capturing is possible under fluorescent, incandescent, LED, or natural light conditions.

For self-interference, a wavefront modulation device for splitting incident object light in half and individually modulating the split incident object light is required. For example, wavefronts are spatially separated, modulated, and then recombined by adopting a conventional Michelson interferometer structure, whereby a self-interference pattern is obtained. Meanwhile, the use of devices with polarization selectivity enables wavefront modulation and interference without splitting the travel path of incident light into two. Representative examples of such devices include systems using a phase-only spatial light modulator (SLM), a birefringent lens, a liquid crystal lens, and a geometrical phase lens. These devices serve to divide the polarization state of incident light into vertical and horizontal components or into left and right circular components and to modulate the curvature of either or both of the components differently.

Particularly, the geometrical phase lens is a passive device in the form of a thin film and acts as a concave or convex lens depending on the circular polarization state of incident light, and when light in a linear polarization state is incident, it acts as a concave lens for half and acts as a convex lens for the other half, thereby modulating the wavefront. Using this device, a self-interference digital holography system capable of reducing the system size to a few centimeters or smaller has been proposed.

Meanwhile, unlike conventional holography technology that uses highly coherent light sources, incoherent holography records the sum of intensities without interference by wavefronts propagated from individual point light sources constituting an object on the image sensor plane. Accordingly, as the number of point light sources increases, bias signals increase compared to meaningful signals, and the meaningful signals become weak when extracting a replicated hologram later. Particularly, when a large amount of noise is caused by optical aberrations and polarization aberrations originating from the optical system of the system, the noise components overlap as the number of point light sources increases, so strong noise components relative to the low signal level result in significant degradation of the reconstruction quality.

However, conventional noise reduction algorithms such as Median filter, Block-Matching and 3D filtering (BM3D), and the like, are not able to effectively remove the noise of acquired holograms.

Also, a deep-learning technique may be used to reduce hologram noise, but it is difficult to clearly understand the mechanism and the inference speed is slow compared to reconstruction using simple convolution.

### SUMMARY OF THE INVENTION

An object of the disclosed embodiment is to reduce a large amount of noise caused when recording an incoherent hologram.

A method for optimizing image quality of an acquired hologram according to an embodiment may include constructing a dataset in which a ground truth image is paired with hologram information acquired from the ground truth image, optimizing a transfer function based on a gradient descent method using the constructed dataset, and restoring noisy hologram information based on the optimized transfer function.

Here, constructing the dataset may include reproducing the ground truth image on a flat panel display, recording an interference pattern for the reproduced ground truth image using the transfer function, and acquiring complex hologram information by processing the recorded interference pattern.

Here, optimizing the transfer function may include generating hologram information by propagating the ground truth image included in a data pair using the transfer function, calculating a loss function between the hologram information included in the data pair and the generated hologram information, and updating the transfer function such that an error by the loss function is minimized.

Here, the transfer function may be initially set to an ideal transfer function.

Here, restoring the noisy hologram information may include generating a complex conjugate component of the optimized transfer function, performing a convolution operation on the complex conjugate component of the transfer function and a target hologram to be restored, and squaring a restored hologram, thereby generating an image from which noise is removed.

Here, when updating the transfer function is performed in a spatial domain, a fast Fourier transform may be respectively performed on the complex conjugate component of the transfer function and target hologram information to be restored, after which a convolution operation may be performed on the complex conjugate component of the transfer function and the target hologram information.

Here, when updating the transfer function is performed in a frequency domain, a convolution operation may be performed on the complex conjugate component of the transfer function and the target hologram after a Fourier transform is performed on the target hologram.

An apparatus for optimizing image quality of an acquired hologram according to an embodiment includes memory in which at least one program is recorded and a processor for executing the program, and the program may perform constructing a dataset in which a ground truth image is paired with hologram information acquired from the ground truth image, optimizing a transfer function based on a gradient descent method using the constructed dataset, and restoring noisy hologram information based on the optimized transfer function.

Here, when constructing the dataset, the program may reproduce the ground truth image on a flat panel display, record an interference pattern for the reproduced ground truth image using the transfer function, and acquire complex hologram information by processing the recorded interference pattern.

Here, when optimizing the transfer function, the apparatus for optimizing image quality of an acquired hologram according to an embodiment may generate hologram information by propagating the ground truth image included in a data pair using the transfer function, calculate a loss function between the hologram information included in the data pair and the generated hologram information, and update the transfer function such that an error by the loss function is minimized.

Here, the transfer function may be initially set to an ideal transfer function.

Here, when restoring the noisy hologram information, the program may generate a complex conjugate component of the optimized transfer function, perform a convolution operation on the complex conjugate component of the transfer function and a target hologram to be restored, and square a restored hologram, thereby generating an image from which noise is removed.

Here, when updating the transfer function is performed in a spatial domain, a fast Fourier transform may be respectively performed on the complex conjugate component of the transfer function and target hologram information to be restored, after which a convolution operation may be performed on the complex conjugate component of the transfer function and the target hologram information.

Here. when updating the transfer function is performed in a frequency domain, a convolution operation may be performed on the complex conjugate component of the transfer function and the target hologram after a Fourier transform is performed on the target hologram.

A method for optimizing image quality of an acquired hologram according to an embodiment may include generating a complex conjugate component of a transfer function optimized in advance, performing a convolution operation on the complex conjugate component of the transfer function and a target hologram to be restored, and squaring a restored hologram, thereby generating an image from which noise is removed.

Here, the transfer function may be optimized by constructing a dataset in which a ground truth image reproduced on a flat panel display is paired with hologram information acquired from the ground truth image and optimizing the transfer function based on a gradient descent method using the constructed dataset.

Here, optimizing the transfer function may include generating hologram information by propagating the ground truth image included in a data pair using the transfer function, calculating a loss function between the hologram information included in the data pair and the generated hologram information, and updating the transfer function such that an error by the loss function is minimized.

Here, when updating the transfer function is performed in a spatial domain, a fast Fourier transform may be respectively performed on the complex conjugate component of the transfer function and target hologram information to be restored, after which a convolution operation may be performed on the complex conjugate component of the transfer function and the target hologram information.

Here, when updating the transfer function is performed in a frequency domain, a convolution operation may be performed on the complex conjugate component of the transfer function and the target hologram after a Fourier transform is performed on the target hologram.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart for explaining a method for optimizing an acquired hologram according to an embodiment;

FIG. 2 is a flowchart for explaining in detail the step of constructing a dataset according to an embodiment;

FIG. 3 is a view illustrating the step of constructing a dataset according to an embodiment;

FIG. 4 is a flowchart for explaining in detail the step of optimizing a transfer function according to an embodiment;

FIG. 5 is a view illustrating the step of optimizing a transfer function according to an embodiment;

FIG. 6 is a view for explaining a gradient descent method;

FIG. 7 is a flowchart for explaining in detail the step of restoring a hologram using an optimized transfer function according to an embodiment;

FIG. 8 is a view illustrating the step of restoring a hologram using an optimized transfer function in a spatial domain according to an embodiment;

FIG. 9 is a view illustrating the step of restoring a hologram using an optimized transfer function in a frequency domain according to another embodiment; and

FIG. 10 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

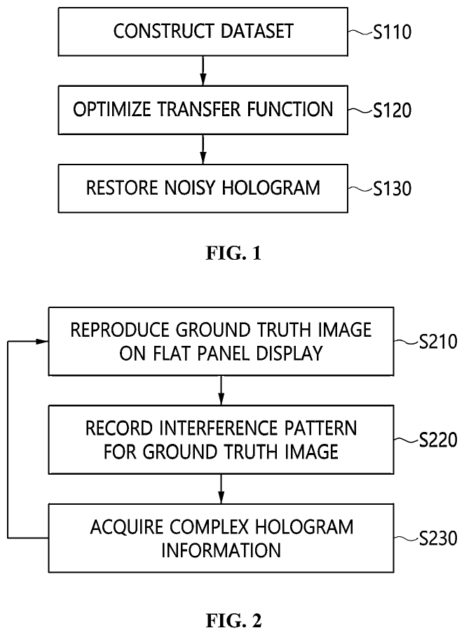

Hereinafter, an apparatus and method for optimizing image quality of an acquired hologram according to an embodiment will be described in detail with reference to FIGS. 1 to 10.

The disclosed embodiment aims to reduce a large amount of noise that is generated when recording an incoherent hologram.

When recording a hologram, the error of an optical system is reflected in a transfer function, but when restoring a hologram, an ideal transfer function is usually used without considering the error of the optical system. Here, the difference between the transfer function used for recording and the transfer function used for restoration results in an increase in noise, and noise accumulates for each point light source, whereby the overall image quality is deteriorated.

Therefore, in order to mitigate the phenomenon resulting from the difference in the transfer function, an embodiment proposes an apparatus and method for acquiring a transfer function in which the error of the optical system is reflected through optimization of the transfer function to reduce the error between an acquired hologram and a ground truth image and for eliminating the error of the image using the acquired transfer function.

FIG. 1 is a flowchart for explaining a method for optimizing an acquired hologram according to an embodiment.

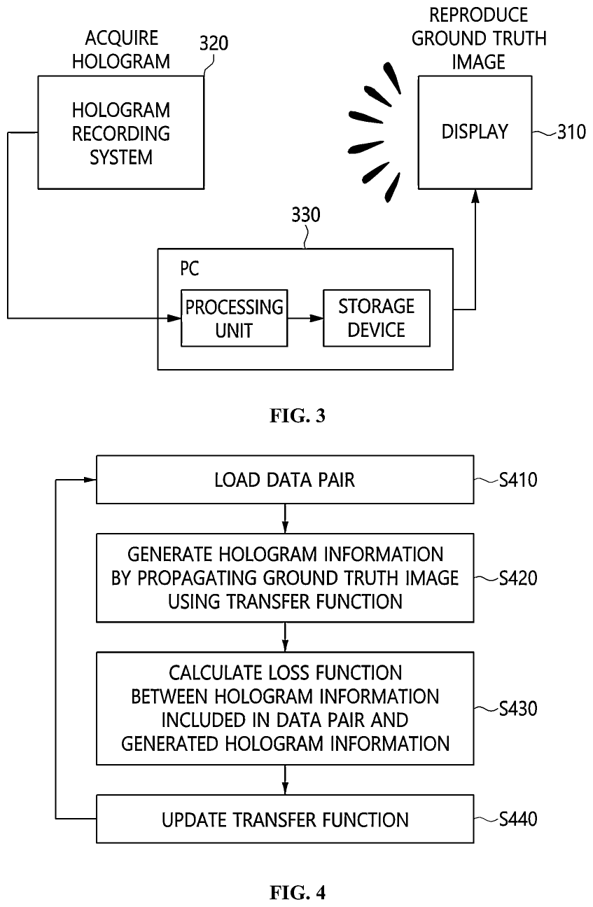

Referring to FIG. 1, the method for optimizing image quality of an acquired hologram according to an embodiment may include constructing a dataset in which a ground truth image is paired with hologram information acquired from the ground truth image at step S110 (FIGS. 2 and 3), optimizing a transfer function based on a gradient descent method using the constructed dataset at step S120 (FIGS. 4 to 6), and restoring noisy hologram information based on the optimized transfer function at step S130 (FIGS. 7 to 9).

Here, constructing the dataset according to an embodiment at step S110 may be performed in order to prevent the transfer function from being overfitted to a single piece of hologram information.

FIG. 2 is a flowchart for explaining in detail the step of constructing a dataset according to an embodiment, and FIG. 3 is a view illustrating the step of constructing a dataset according to an embodiment.

Referring to FIG. 2, constructing the dataset according to an embodiment at step S110 may include reproducing a ground truth image on a flat panel display at step S210, recording an interference pattern for the reproduced ground truth image using a transfer function at step S220, and acquiring complex hologram information by processing the recorded interference pattern at step S230.

Referring to FIG. 3, assuming that information of the ground truth image reproduced on the flat panel display 310 is l, the interference pattern is recorded in a hologram recording system 320 by the transfer function \tilde{H} in which the error of an optical system is reflected, and the apparatus 330 for optimizing image quality of an acquired hologram processes the recorded interference pattern, whereby complex hologram information ũ may be configured.

Here, when a total of N data pairs are recorded, the relationship between the ground truth image Iₙ and hologram information [symbol] of the n-th data pair (n being an arbitrary value between 1 and N) may be represented as shown in Equation (1) below:

$${ℱ}^{- 1} [ ℱ [ {I}_{n} ] ∘ \tilde{H} ] = \qquad ( 1 )$$

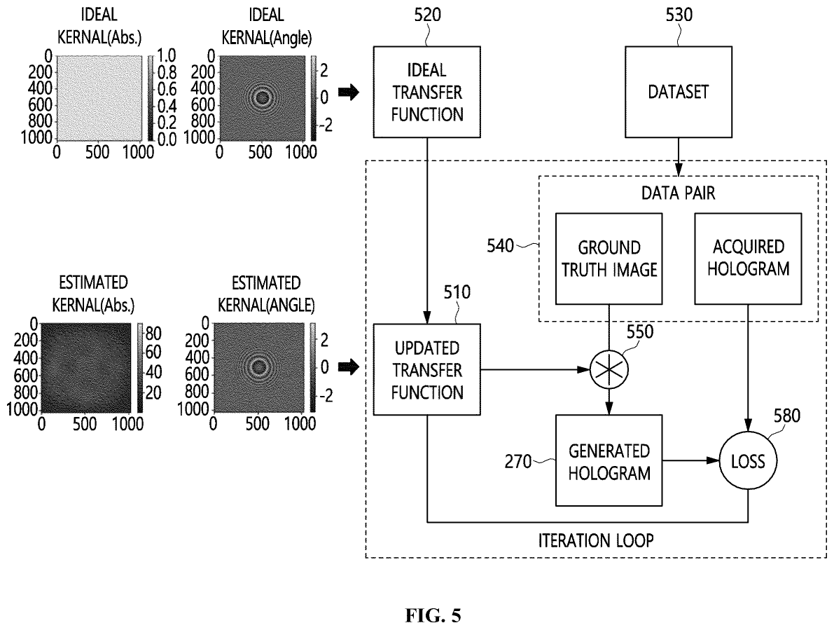

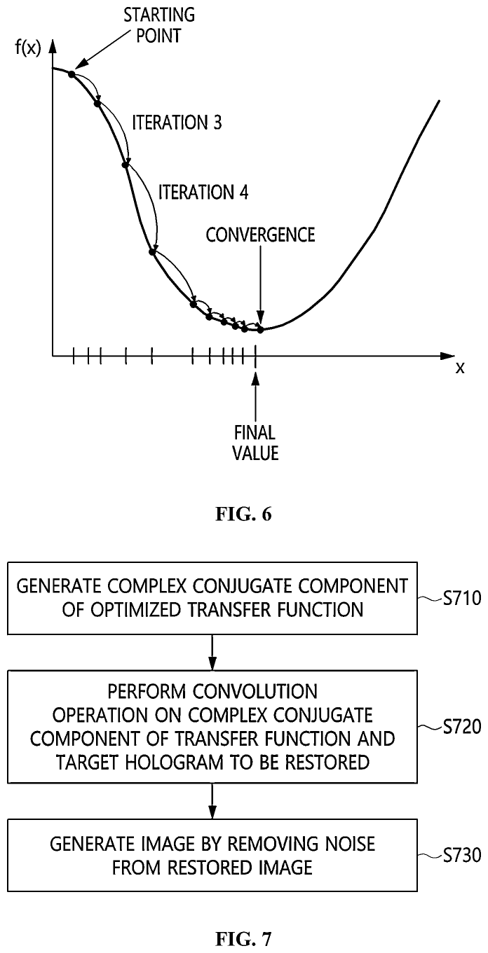

FIG. 4 is a flowchart for explaining in detail the step of optimizing a transfer function according to an embodiment, FIG. 5 is a view illustrating the step of optimizing a transfer function according to an embodiment, and FIG. 6 is a view for explaining a gradient descent method.

Referring to FIG. 4, optimizing a transfer function according to an embodiment at step S120 may include generating hologram information by propagating the ground truth image included in a data pair using a transfer function at step S420, calculating a loss function between the hologram information included in the data pair and the generated hologram information at step S430, and updating the transfer function at step S440 such that the error by the loss function is minimized.

Here, referring to FIG. 5, the transfer function 510 may be set to an ideal transfer function H 520 at first. For example, the first transfer function in the Fourier domain may be defined as an angular spectrum kernel as shown in Equation (2) below:

$$H = \{ \begin{matrix}exp \{ - j \frac{2 π}{λ} z \sqrt{1 - {( λ {f}_{x} )}^{2} - {( λ {f}_{y} )}^{2}} \} , if \sqrt{{f}_{x}^{2} + {f}_{y}^{2}} < \frac{1}{λ} \\ 0 , otherwise\end{matrix} \qquad ( 2 )$$

When generating the hologram information according to an embodiment at step S420, the ground truth image Iₙ included in the n-th data pair (Iₙ, [symbol] ) 540, which is loaded from the dataset 530 at step S410, is propagated using the ideal transfer function as shown in Equation (3) below, whereby a noise-free hologram uₙ 570 is generated.

$${ℱ}^{- 1} [ ℱ [ {I}_{n} ] ∘ H ] = {u}_{n} \qquad ( 3 )$$

In Equation (3), ∘denotes element-wise multiplication.

Subsequently, when calculating the loss function according to an embodiment at step S430, the acquired hologram information [symbol] included in the data pair 540 is compared with the generated hologram information uₙ 570, whereby the loss function 580 defined in Equation (4) below is calculated.

$$ℒ ( {u}_{n} , ) \qquad ( 4 )$$

Subsequently, when updating the transfer function according to an embodiment at step S440, the transfer function value may be updated such that the error by the loss function is minimized according to the gradient descent method.

Here, the gradient descent method calculates the loss function by a specific system parameter and determines a change in the parameter using the gradient value between the previous and current loss functions, as illustrated in FIG. 6, thereby optimizing the system such that the loss function is minimized. With the recent development of deep-learning technology, optimization techniques based on famous gradient descent methods, such as Stochastic Gradient Descent (SGD), ADAM, and the like, in the form of various packages, such as TensorFlow, PyTorch, etc., have been introduced such that the optimization techniques can be more conveniently used.

Therefore, through the above-described process, the ideal transfer function H may be optimized into the transfer function \tilde{H} in which the error of the optical system is reflected, as shown in Equation (5) below:

$${min}_{H} ℒ ( {u}_{n} , ) for H \to \tilde{H} \qquad ( 5 )$$

FIG. 7 is a flowchart for explaining in detail the step of restoring a hologram using an optimized transfer function according to an embodiment.

Referring to FIG. 7, restoring the noisy hologram information according to an embodiment at step S130 may include generating a complex conjugate component of the optimized transfer function at step S710, performing a convolution operation on the complex conjugate component of the transfer function and the target hologram to be restored at step S720, and squaring the restored hologram, thereby generating an image from which noise is removed at step S730.

Here, the target hologram [symbol] to be restored is a noisy hologram, and it may be an arbitrarily acquired hologram, rather than being acquired from the dataset.

Also, the optimized transfer function \tilde{H} is used for propagation from the image to the holographic surface, so the conjugate component \tilde{H}* may be used for restoration in order to propagate in the reverse direction.

When performing the convolution operation according to an embodiment at step S720, the convolution operation may be performed on the complex conjugate component \tilde{H} * of the transfer function and the target hologram [symbol] to be restored, as shown in Equation (6) below:

$${ℱ}^{- 1} [ ℱ [ {\tilde{u}}^{′} ] ∘ {\tilde{H}}^{*} ] = {u}^{′} \qquad ( 6 )$$

Subsequently, the restored hologram u′ is converted to intensity, as shown in Equation (7) below, whereby an image from which noise is removed (I′) may be obtained.

$${\vert {u}^{′} \vert}^{2} = {I}^{′} \qquad ( 7 )$$

Meanwhile, updating the transfer function may be performed in a spatial domain or a frequency domain. Here, the effect may be different depending on the optical system.

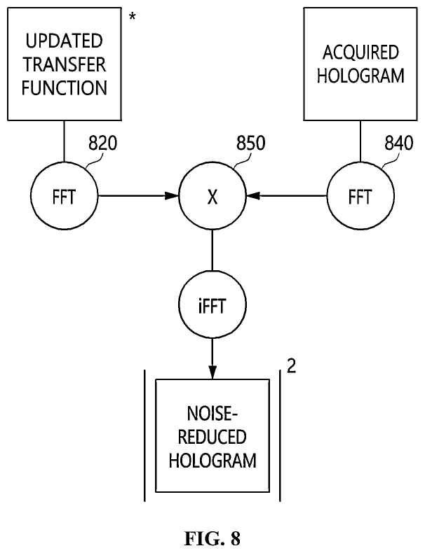

FIG. 8 is a view illustrating the step of restoring a hologram using an optimized transfer function in a spatial domain according to an embodiment.

Referring to FIG. 8, when the optimizing step (S120) according to an embodiment is performed in the spatial domain, fast Fourier transforms 820 and 840 are respectively performed on the complex conjugate component of the transfer function and the target hologram information to be restored, after which the convolution operation 850 may be performed on the complex conjugate component of the transfer function and the target hologram information.

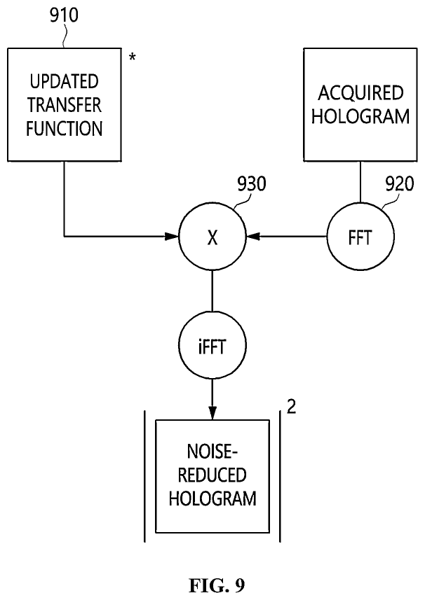

FIG. 9 is a view illustrating the step of restoring a hologram using an optimized transfer function in a frequency domain according to another embodiment.

Referring to FIG. 9, when the optimizing step (S120) according to an embodiment is performed in the frequency domain, a convolution operation 930 may be performed on the complex conjugated component 910 of the transfer function and the target hologram to be restored after a fast Fourier transform 920 is performed on the target hologram.

Meanwhile, when there is a transfer function optimized for a specific depth, a hologram may be restored using the transfer function, as described above, and an image focused on another depth may be restored through additional propagation without the process of converting into intensity.

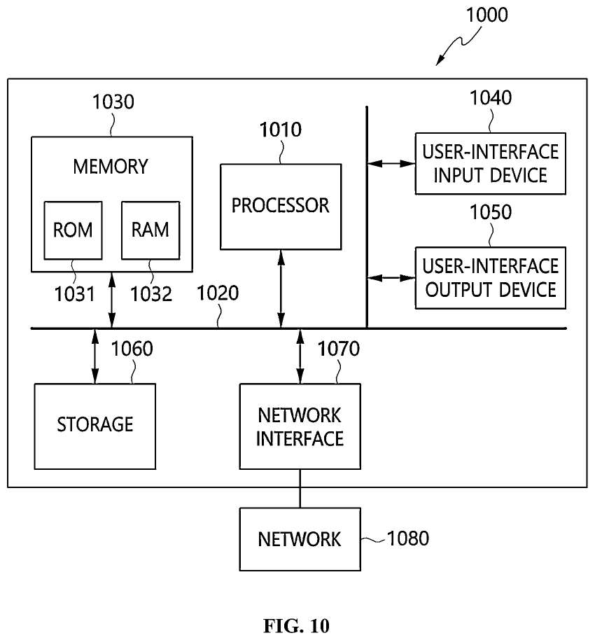

FIG. 10 is a view illustrating a computer system configuration according to an embodiment.

The apparatus for optimizing image quality of an acquired hologram according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, a hologram is restored by reflecting the error of an optical system, whereby noise may be effectively reduced.

According to the disclosed embodiment, a complex hologram enters as input and a complex hologram comes out as output, so additional numerical propagation is possible, and the hologram may be reproduced on a complex hologram display without change or with only slight modifications.

According to the disclosed embodiment, if a transfer function for a single object distance is trained, a volume may be restored using the corresponding transfer function.

According to the disclosed embodiment, it is possible to restore an image with simple convolutional operations, so the restoration is sped up, compared to a deep-learning method.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A method for optimizing image quality of an acquired hologram, comprising:
constructing a dataset in which a ground truth image is paired with hologram information acquired from the ground truth image;
optimizing a transfer function based on a gradient descent method using the constructed dataset; and
restoring noisy hologram information based on the optimized transfer function.

2. The method of claim 1, wherein constructing the dataset comprises
reproducing the ground truth image on a flat panel display;
recording an interference pattern for the reproduced ground truth image using the transfer function; and
acquiring complex hologram information by processing the recorded interference pattern.

3. The method of claim 1, wherein optimizing the transfer function comprises
generating hologram information by propagating the ground truth image included in a data pair using the transfer function;
calculating a loss function between the hologram information included in the data pair and the generated hologram information; and
updating the transfer function such that an error by the loss function is minimized.

4. The method of claim 3, wherein the transfer function is initially set to an ideal transfer function.

5. The method of claim 3, wherein restoring the noisy hologram information comprises
generating a complex conjugate component of the optimized transfer function;
performing a convolution operation on the complex conjugate component of the transfer function and a target hologram to be restored; and
squaring a restored hologram, thereby generating an image from which noise is removed.

6. The method of claim 5, wherein, when updating the transfer function is performed in a spatial domain, a fast Fourier transform is respectively performed on the complex conjugate component of the transfer function and target hologram to be restored, after which a convolution operation is performed on the complex conjugate component of the transfer function and the target hologram information.

7. The method of claim 5, wherein, when updating the transfer function is performed in a frequency domain, a convolution operation is performed on the complex conjugate component of the transfer function and the target hologram after a Fourier transform is performed on the target hologram.

8. An apparatus for optimizing image quality of an acquired hologram, comprising:
memory in which at least one program is recorded; and
a processor for executing the program,
wherein the program performs
constructing a dataset in which a ground truth image is paired with hologram information acquired from the ground truth image, optimizing a transfer function based on a gradient descent method using the constructed dataset, and restoring noisy hologram information based on the optimized transfer function.

9. The apparatus of claim 8, wherein, when constructing the dataset, the program reproduces the ground truth image on a flat panel display, records an interference pattern for the reproduced ground truth image using the transfer function, and acquires complex hologram information by processing the recorded interference pattern.

10. The apparatus of claim 8, wherein, when optimizing the transfer function, the program generates hologram information by propagating the ground truth image included in a data pair using the transfer function, calculates a loss function between the hologram information included in the data pair and the generated hologram information, and updates the transfer function such that an error by the loss function is minimized.

11. The apparatus of claim 10, wherein the transfer function is initially set to an ideal transfer function.

12. The apparatus of claim 10, wherein, when restoring the noisy hologram information, the program generates a complex conjugate component of the optimized transfer function, performs a convolution operation on the complex conjugate component of the transfer function and a target hologram to be restored, and squares a restored hologram, thereby generating an image from which noise is removed.

13. The apparatus of claim 12, wherein, when updating the transfer function is performed in a spatial domain, a fast Fourier transform is respectively performed on the complex conjugate component of the transfer function and target hologram to be restored, after which a convolution operation is performed on the complex conjugate component of the transfer function and the target hologram information.

14. The apparatus of claim 12, wherein, when updating the transfer function is performed in a frequency domain, a convolution operation is performed on the complex conjugate component of the transfer function and the target hologram after a Fourier transform is performed on the target hologram.

15. A method for optimizing image quality of an acquired hologram, comprising:
generating a complex conjugate component of a transfer function optimized in advance;
performing a convolution operation on the complex conjugate component of the transfer function and a target hologram to be restored; and
squaring a restored hologram, thereby generating an image from which noise is removed.

16. The method of claim 15, wherein the transfer function is optimized by
constructing a dataset in which a ground truth image reproduced on a flat panel display is paired with hologram information acquired from the ground truth image; and
optimizing the transfer function based on a gradient descent method using the constructed dataset.

17. The method of claim 16, wherein optimizing the transfer function comprises
generating hologram information by propagating the ground truth image included in a data pair using the transfer function;
calculating a loss function between the hologram information included in the data pair and the generated hologram information; and
updating the transfer function such that an error by the loss function is minimized.

18. The method of claim 17, wherein, when updating the transfer function is performed in a spatial domain, a fast Fourier transform is respectively performed on the complex conjugate component of the transfer function and target hologram information to be restored, after which a convolution operation is performed on the complex conjugate component of the transfer function and the target hologram information.

19. The method of claim 17, wherein, when updating the transfer function is performed in a frequency domain, a convolution operation is performed on the complex conjugate component of the transfer function and the target hologram after a Fourier transform is performed on the target hologram.
